(19) United States
(12) Patent Application Publication
(10) Pub. No.: US 2005/0021666 A1
(43) Pub. Date: Jan. 27, 2005

(54) System and method for interactive communication between matched users

(76) Inventors: David M. Dinnage, Delham, MA (US); Christopher J. Bell, Los Angeles, CA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/681,573

(22) Filed: Oct. 8, 2003

Related U.S. Application Data
(60) Provisional application No. 60/416,839, filed on Oct. 8, 2002.

(51) Int. Cl. G06F 15/16

(52) U.S. Cl. 709/217; 709/203

(57) ABSTRACT

A system for matching users with profile data of interest to that user is provided to establish real-time interactive communication with another user related to the matched profile data. The system includes a matching database system that allows for entering profile data, a matching a user's profile to other profiles, and sending notification messages to a user to indicate matches made. The matching database system also has stored therein a plurality of profiles containing profile data. The system further allows users to communicate with the matching database system to enter profiles containing profile data and to receive the notification messages. The notification messages sent by the matching database system further allow the user receiving a notification message to communicate interactively in real-time with a representative of a matched profile.

### RELATED APPLICATIONS

This application claims priority to Provisional U.S. Patent Application Ser. No. 60/416,839, entitled System and Method for Wireless Communication, and filed on Oct. 8, 2002, which provisional application is incorporated by reference herein in its entirety including its Appendix.

### FIELD OF THE INVENTION

The present invention relates to a system and method for the transmission of data to a user's mobile device. More specifically, the invention relates to a system and method for communicating data matching a user's preferences on a database to that user's device. Likewise, the user may communicate interactively with another user and/or service provider utilizing a mobile device to provide transaction data in the form of text, audio, or graphic means to communicate instantaneously or latently.

### BACKGROUND OF THE INVENTION

As known in the art, advertising and personal ads attempt to solicit the potential interests of people through print media such as newspapers, magazines, and billboard advertisements. Electronic means such as radio and television have also been employed to solicit the interests of potential consumers. Recently, the Internet, also known as the World Wide Web, has attempted to solicit the interest of potential consumers by the use of electronic advertisement such as flash banners and electronic mail.

Due to the low cost of advertising and communicating information electronically, many advertisers, marketers, and individuals solicit targeted and untargeted data to users in hopes of attaining interest or transacting commerce. This approach has been ineffective even with the use of a user's profile to match preferences designated by the user. A user may receive related or unrelated matches.

Recently, mobile service providers have offered consumers the ability to connect to the Internet through wireless devices to access information or conduct e-commerce. Recognizing that many people may utilize mobile devices such as personal digital assistants (PDA), mobile phones, etc. to access the Internet for information, communication, or purchasing products or services; individuals and product/service providers have attempted to communicate information to potential consumers by electronic messaging means including SMS, electronic paging, email, facsimile, etc. to a user's mobile device. Prior to receiving such services, the consumer would need to provide certain criteria to create a user profile to be stored in a database on a network. When a match is made to the user's profile, a message in the form of text is then sent to the user's mobile device. However, a disadvantage to this approach is that the user may receive irrelevant or outdated information and may not be able to access information, products or services in a timely manner.

Wireless devices also allow the user great mobility. Upon receipt of information corresponding to a user's preference; he/she may not be able to access such services readily as they may be beyond the service provider's boundaries to deliver products or services.

Accordingly, it would be desirable to provide a system for users to receive information accessible through a wireless device from a network that provided personalized information that is compared for proximity to user's preferences and allows the users to respond instantaneously or at a later time to communicate information or purchase products or services.

### SUMMARY OF THE INVENTION

The present invention provides an information distribution system where a user's preferences are matched to a database within a network. Information is sent from a network to a user via a mobile device. The user receives the information by electronic messaging means.

In another aspect of the invention, information is sent by a user to a network database system, which then matches the user's criteria and communicates by messaging means the matches. The system can also determine the quality of those matches, i.e. perfect or close match, transmit by electronic messaging means in the form of text, audio, or graphics, allow the user to retrieve information from a database for services or information based upon the user's pre-selected or selected geographic area, notify the user whether communication with another user or service provider is available in real-time, allow the user to respond to the information by sending data in the form of text, audio, or graphics, and present the user with choices to purchase services through an electronic payment system.

In yet another aspect, the present invention is an information system that calculates the frequency of a user's response to information communicated from a network database to the user's wireless device. A user's purchase of products or services are also tracked in the network database. The invention then adjusts the frequency of delivered information to the user's mobile device to correspond to the user's participation in communicating with other users and purchasing products or services. Thereby the system interactively attempts to solicit the interests of users.

It should be noted that the system can be applied to a wide variety of services, e.g. dating, job searching, product or service offerings. The purchased products or services are delivered via electronic messaging means to the mobile device with pricing, product/service information including text and graphics, purchasing options by electronic means, and product or service availability.

### BRIEF DESCRIPTION OF THE DRAWINGS

The invention will be more fully understood from the following detailed description taken in conjunction with the accompanying drawings:

FIG. 1 provides a diagrammatic view of a system of the present invention;

FIG. 2 provides an overview of a method in accordance with the present invention;

FIG. 3 is an expanded detail presentation of the comparison methods by which matches provided in FIG. 2 are identified;

FIG. 4 is an expanded detail presentation of one of the methods by which the matching of FIG. 1 is initiated;

FIG. 5 is an expanded detail presentation of an additional method by which matching is initiated; and

FIG. 6 is an expanded detail presentation of the methods by which users are notified by mobile and wired devices.

### DETAILED DESCRIPTION OF THE INVENTION

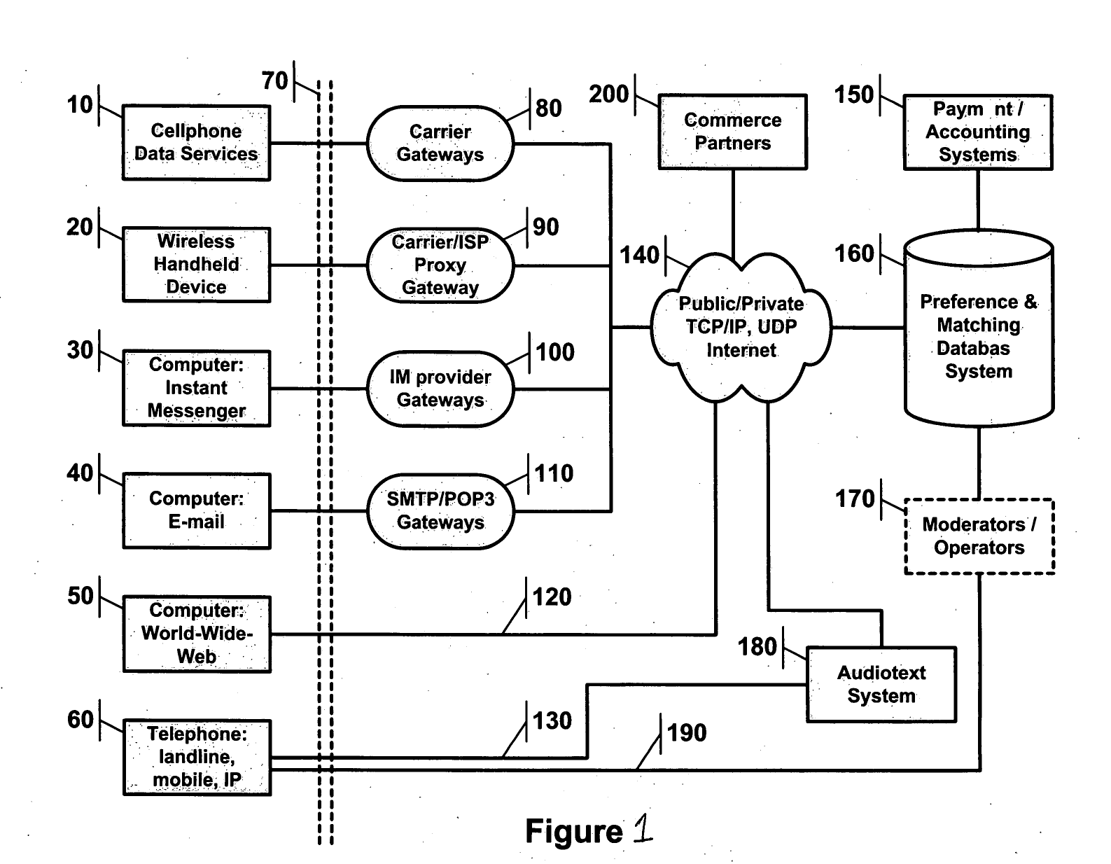

Referring to the drawings in additional detail, FIG. 1 illustrates a system of the invention for accepting characteristic and/or criteria data from a user, for determining matches between a user and a person and/or object having characteristic and/or criteria data that matches with the data provided by the user, and for generating and delivering notification messages detailing those matches, including at least one interactive notification message that allows the user to communicate with the object of that user's match in real time.

FIG. 1 illustrates a number of fundamental system components and points of user interaction for joining and entering data, being matched, receiving notification of matches, interacting with the notifications, transacting commerce, and other aspects of the current invention. In general, a system of the invention need not include each and every element illustrated in the Figure, but only as many of the illustrated elements as are needed to carry out the purpose of a given aspect of the invention.

A typical user of a system of the invention can interact with the system using one of methods shown to left of the marker shown 70 (collectively referred to as user interaction elements 70) in order to communicate, ultimately, with Preference and Matching Database 160. In one embodiment, a system user may connect using Short Message Service (SMS) messages sent and received from a wireless handheld device such as, for example, a Nokia 3595 model handset 10, connecting via a Global System for Mobile (GSM) network such as that as provided by AT&T Wireless Services (ATTWS) utilizing ATTWS's standard SMS gateway 80 to connect via Simple Mail Transfer Protocol (SMTP) over the public Internet 140 to reach Preference and Matching Database System 160.

In another embodiment, a user may use the same wireless handheld device (in this example a Nokia 3595 model handset) 10, but now connecting using nMode wireless Internet access as provided by ATTWS using a custom gateway 80 as a proxy to standard Hypertext Transfer Protocol (HTTP) for connecting to Preference and Matching Database System 160 through the public Internet 140. In yet other embodiments, users can connect utilizing data and text services provided through a variety of carriers using an appropriate cellular telephone 10, connecting through a matching proxy or gateway 80, using standard communications protocols through either dedicated or public Internet connections to Preference and Matching System 160.

A further alternative means for a user to interact with Preference and Matching Database System 160 is via a different wireless handheld device 20 such as a Palm i705 wireless personal digital assistant which, when running a custom application as part of this invention, offers wireless service using infrastructure provided by Palm.Net 90 to provide a standardized proxy interface to HTTP communications serviced by Preference and Matching System 160.

Yet another means of access to the system by users is through the use of commercial, free, or customized Instant Messaging Services. In one embodiment, a user may utilize the AOL Instant Messaging Client 30 on a Dell Dimension model L733r personal computer under the Microsoft Windows 2000 Professional operating system to communicate with the invention's Preference and Matching Database System 160 through standardized intermediate protocols as defined by the instant messaging service provider requirements 110. This communication means (as well as the computer based means described below), could be wired, wireless, or a combination of wired and wireless (such as a connection through a Wi-Fi “hot spot” to a wired network).

An additional method for users to interact with the present invention is through the use of standard electronic mail (e-mail) through the use of a personal computer such as a Dell Dimension model L733r personal computer under Microsoft Windows 2000 Professional 40 utilizing a communications program such as Microsoft Outlook 2000 to send and receive e-mail through a commercial Internet Service Provider utilizing standard protocols such as SMTP and Post Office Protocol 3 (POP3) 110. Other similar configurations of e-mail software, ISPs, and standard communication protocols are anticipated as part of the current invention.

Yet a further means of interaction with the present invention is via World Wide Web information browsers which run on a variety of personal computing platforms 50. The browsers, which allow for display and interaction with content comprising of Hypertext documents and standardized and custom client applications, are used to send and receive information from the Preference and Matching Database System 160 through HTTP or similar protocols 120 through public or private Internet connections 140. In one embodiment, a system user utilizes the Microsoft Internet Explorer web browser utilizing the Microsoft Windows 2000 Professional operating system on a Dell Dimension model L733r personal computer 50 which sends and receives data from the Preference and Matching Database System 160 via HTTP 120 through a connection to the public Internet enabled through commercial ISP data connection services provided by AT&T 140. The use of alternative browsers such as Opera, Netscape Navigator, Blaze and other running on a wide range of computing devices are envisioned as part of the present invention.

Another means for users to interact with the current invention is via voice or DTMF telephone touch tones, utilizing a digital or analog, mobile or fixed telephone 60 over standard voice circuits 130 to connect to a customized Audiotext System 180 which in turn interfaces with the Preference and Matching Database System 160 using data protocols through private data connections 140. In one embodiment, a user, utilizing a Lucent 7406 Plus office telephone 60 makes a toll-free telephone call utilizing AT&T long distance PSTN service 130 which is answered by a custom-developed voice-enabled application utilizing Sonexis Show N Tel development and run-time software on an audiotext system running the Windows NT Workstation operating system 180. Additionally, users may speak directly to a call center representative 170 using the same telephone equipment connecting using standard means of voice communication 190. Call center representatives act on behalf of the user utilizing custom data entry software developed using Great Plains Dexterity, Microsoft Visual Basic NET or other tools to interact with the Preference and Matching Database System 160.

In one embodiment according to the present invention, Preference and Matching System 160 can include a linked farm of multiple Dell PowerEdge 2650 Servers running Microsoft SQL Server 2000 Enterprise Edition under the Microsoft Windows 2000 operating system and system 160 includes characteristic and/or criteria data entered by users. Preference and Matching Database System 160 generally includes interface and processing software, database code, and data structures as required in order to carry out the matching functions described below. System 160 can also interact with payment processing and accounting systems 150 in order to maintain desired user service billing on time-based subscription, per-use charging, or other metered use bases. For example, and without limiting the invention in any way, a per-message billing model such as that described in U.S. Pat. No. 5,913,212, entitled Personal Journal and issued on Jun. 15, 1999 (incorporated herein by reference), could be employed within a system of the present invention.

One important function of Preference and Matching Database System 160 is to store preferences of users of the system and, in particular, to store characteristic information relating to the users and/or criteria information relating to other users or objects with which the user would like to find a match. In one embodiment of the invention, Preference and Matching Database System 160 is designed to match users to other users as part of an on-line personals advertisement matching system. In such an embodiment, as well as others described herein, the features of on-line personal advertisement matching systems described in U.S. Pat. No. 6,052,122, entitled Method and Apparatus for Matching Registered Profiles, and issued on Apr. 18, 2000; U.S. Pat. No. 6,073,105, entitled Interactive Personals Online Network Method and Apparatus, and issued on Jun. 6, 2000; U.S. Pat. No. 6,249,282, entitled Method and Apparatus for Matching Registered Profiles, and issued on Jun. 19, 2001; and U.S. Pat. No. 6,253,216, entitled Method and Apparatus for Providing a Personal Page, and issued on Jun. 26, 2001 (each of which is incorporated herein by reference) can be used.

An on-line personals system (“PON” or personals on-line network) of this embodiment may include personals advertisements as well as more specific profile information regarding the advertising user and regarding the type of person that the advertising user would like to meet. In this case, Preference and Matching Database System 160 provides searching/matching facilities which allow users of the system to search other users' profiles in an attempt to find a match. In the on-line personal advertisement system described herein, reference is made to characteristic and criteria data. As used herein, characteristic data refers to information that describes a user. For example, characteristic data elements associated with the first user refer to the gender of the first user, the drinking habits of the first user, and other such information. Criteria data refers to the characteristics preferred in another user by the first user. For example, the criteria data of the first user can include a requirement that another user be a specified gender or that another user have certain drinking patterns. Thus, characteristic data refers to the first user and criteria data refers to the preferences of the first user with respect to another user.

In an exemplary embodiment, characteristic and criteria data can be obtained from a number of users and the obtained characteristic and criteria data can be stored in first and second tables, wherein a row is provided for each user of the system. In one embodiment, the first table, Table I below, stores data that in an illustrative embodiment must be provided in order to do a search. This data is the gender and type of association that is desired in another user. The second table, Table II below, is an illustrative embodiment of a table storing data associated with a user including exemplary characteristic and criteria data.

TABLE I

FIELD
USER_ID
SEEK_GENDER
SEEK_FOR

TABLE II

| FIELD | DESCRIPTION |
|---|---|
| USER_ID | Handle |
| SEQ_ID | sequential ID |
| CLIENT_ID | identifies client publisher |
| BOX_NO | mailbox from audiotext system to record |
| | greeting |
| INTERNET | user sign up from Internet? |
| FLAGS | i.e., send automatch mailings? |
| PRIV_PW | login password |
| VRFY_PASSWD | verify email addresses reply mail |
| VERIFIED | has email address been verified? |
| PERSONAL_TEMP | template code for personal page being edited |
| PERSONAL_PG | template code of personal page |
| STAMPS | number of stamps that have been paid for |
| CREATED | date user created |
| LAST_ACT | last login date |
| MATCHED | date user was last matched |
| FNAME | first name |
| LNAME | last name |
| ADDR_A | first address |
| ADDR_B | second address |
| CITY | city |
| STATE | state |
| ZIP | zip code |
| COUNTRY | country |
| AREACODE | area code |
| PHONENUMBER | phone number |
| GET_MAILINGS | get mailings? |
| EMAIL | have email? |
| HEADLINE | headline of personal ad |
| BODY | body of ad |
| EXPIRES | date web ad expires |
| STATUS | approved, unapproved, or rejected |
| SEX | gender |
| BIRTHDAY | date of birth |
| ETHNO | ethnicity |
| RELIGION | religion |
| CHILDREN | parental status |
| SMOKING | smoking status |
| DRINKING | drinking status |
| BODY_TYPE | type of body |
| EDUCATION | educational background |
| HEIGHT | height |
| AGE | age |
| LOCATION | location |
| LATITUDE | geographic latitude |
| LONGITUDE | geographic longitude |
| ETHNO_PREF | preferred ethnicity |
| RELIGION_PREF | preferred religious affiliation |
| CHILDREN_PREF | preferred parental status |
| SMOKING_PREF | preferred smoking status |
| DRINKING_PREF | preferred drinking status |
| BODY_TYPE_PREF | preferred body type |
| EDUCATION_PREF | preferred educational level |
| HEIGHT_MIN | preferred minimum height |
| HEIGHT_MAX | preferred maximum height |
| AGE_MIN | preferred minimum age |
| AGE_MAX | preferred maximum age |
| LOCATION_PREF | preferred geographical location |
| HAS_PROFILE | have a profile? |
| HAS_GREETING | have a greeting? |
| HAS_REMOTE_{—} | have an audiotext greeting? |
| GREETING | |

Tables I and II are exemplary embodiments and no embodiment of the invention should be limited this characteristic and criteria data or the method of storing the data. Also, the user may choose not to provide certain characteristic data and may decline to specify a preference with respect to one or more of the criteria data elements.

In use, a first user can request a search of the database for other users based on characteristic and criteria data. In another embodiment, the system can periodically examine the database to search for users for which there is a bi-directional match of characteristic and criteria data. In one exemplary matching approach, a search string can be formed to match the first user criteria data with the characteristic data of other users and the first user characteristic data with the criteria data of the other users. After forming the search string, the database of characteristic and criteria data can be searched using the string to obtain a list of matches.

In one embodiment, a match represents a match of each of the specified criteria elements of the first user and the at least one other user. More specifically, each of the criteria data elements that have been specified by the users is met by the respective other user. In a further embodiment, a match can represent a match of less than all of the criteria elements. For example, all the criteria elements of first user are met by the characteristic data of another user except for one element. Thus, a close match can be made and communicated as such to the first user. In one embodiment, inexact matches are provided in the case where no exact matches are found, or some limited number.

In a further embodiment of the invention, the results of a search are ordered in relation to the quality of a match. For example, search results can be ordered by examining the priority of particular criteria data elements assigned by users. In a further example, the user may assign a priority between one and ten inclusive to each criteria element wherein multiple elements can be assigned the same priority. In another embodiment, each of the criteria elements can be assigned a priority from most to least important. Thus, for twenty criteria elements, the elements would be assigned a priority from one to twenty, with each element having a unique priority between one and twenty inclusive. The priority data assigned to each element can be included as part of a search string. Further embodiments include ordering the search results based on interactive messaging capability (and whether that capability is active at the time that the matching is performed), voice-greeting status, on-line personal ad status, system identification number, geographical closeness, closeness in age, astrological closeness, response level to personal ad, likelihood of responding to an interactive message, and most recent system interaction.

Matching results and/or the quality ranking of matching results may also be influenced by passively collected parameters as well as or in place of characteristic and criteria data entered by users. For example, where an on-line personals system is part of a larger system that also includes ticketing for cultural events such as movies, concerts or sporting events, information about a given user's purchases of such tickets can be stored and can be compared to the purchasing activities of other users using collaborative filtering or other methods to match users having similar interests.

In other embodiments of the invention, Preference and Matching Database System 160 can be designed for differing types of matches. For example, a system of the invention could match users with employment opportunities. Users could enter characteristic information that would include their qualifications and other information typically found on a cirruculum vitae, as well as criteria information such as salary requirements, geographical requirements or other requirements that employment candidates typically have. This characteristic and/or criteria could then be matched with characteristic (salary, title, location, etc.) and/or criteria (qualifications, etc.) data for open employment positions. As with other matching operations, matches found could be ranked in terms of quality, and matches could be performed on demand, or on a scheduled basis. Still further, interactive messaging could be used, as used above and as further described below, for a user who matches with an employment opportunity to communicate in real time with a professional recruiter of human resources representative regarding the opportunity in question. In further embodiments of the invention, matching can be employed to connect people with other people or objects in a variety of circumstances. For example, a user might wish to find real estate, and could be matched with available real estate based upon characteristic (down payment available, time frame for purchase or renting, has pets or children, pre-qualified for a mortgage to a certain level, etc.) and/or criteria (size, number of bedrooms, location, etc.) data and could communicate interactively with a real estate agent or property manager regarding the real estate.

In general, a user may have one or more predefined profiles containing characteristic and/or criteria data, or may enter or modify such data on the fly. For example, a user might maintain a profile of characteristic and/or criteria data within a system of the invention dedicated to personals matching for the purpose of finding a person suitable for a long term relationship. That same user might find him or herself with an extra ticket to a baseball game or museum event on a particular day for which that person would like to find a match that might involve different characteristic or criteria data for matching. For example, the criteria might in this instance include being a baseball fan or art lover. Using the system of the invention, such a person would be able to enter or modify his or her characteristic and/or criteria data, make one or more matches ranked in order of quality, and communicate interactively with one or more of the matches to find a companion for that baseball game or museum event.

Once one or more matches are made, the user being matched is notified of the match or matches by means of a notification message. In a preferred embodiment, the notification message is interactive, that is, it allows the receiver of the message to begin real-time, interactive communication with another user to whom the first user is matched, or with another user or a commerce partner 200 who represents a matched object or event. In a further preferred embodiment, the communication is anonymous.

As an example in the context of an on-line personals system, a user can join or log in to the system through a handheld wireless device that is capable of communicating using SMS messaging. If joining, the user may be asked to answer a series of questions in order to create a profile of characteristic and/or criteria data. If the user is already a member, the user might elect to use a pre-existing profile, or to create a new one for the purposes of requesting a match at that point in time. When the user requests a match, that request is communicated to Preference and Matching Database System 160 as described above and the Preference and Matching Database System responds to the user with one or more matches ranked in order of quality of the match. In addition, the matches may be ranked, or may be based upon, the availability of the matched users to communicate interactively at that time and whether they are available on a communications device that is compatible for communicating with the first user. The system may also, if there is a high quality match that is not presently available for real-time communication, notify the user of that match by other means—for example by email so that the user may respond to that match later and in another manner.

The ordered list of matches can then be presented on the user's device along with, for example, greetings that are included in the profiles of those who are matched. The user can then select one of the matches for interactive communication. In the embodiment in which the communication is anonymous, the matches may be provided with anonymous/arbitrary identification numbers that can facilitate anonymous communication. Responding to such a match, say by SMS messaging, will result in the user's own anonymous identification number being attached to the message so that the matched user may respond in real time while maintaining the anonymity of each user. Under appropriate circumstances, these users might choose to reveal their identities to each other.

The anonymity feature has obvious advantages in the personals context as users would likely desire the ability to get to know someone through the communications described above before revealing their identity or other personal information. Such anonymity could also be advantageous in other contexts, such as the employment search situation in which the user might not want others to know that he or she is looking for a job and would only like to disclose his or her identity after making sure, through the communication described above, that he or she is very interested in a particular opportunity.

Additionally, in some embodiments of the invention, call center representatives or other personnel may act as live moderators 170 to interact with paying or complimentary users of the services provided by the invention. In addition to the ability to act as peers to normal system users, moderators manage functionality in the Preference and Matching Database System 160 by addressing customer service requests, modifying data, adjusting searching and matching criteria, and otherwise interacting with the system and users.

Another aspect of the current invention allows for communications from the members to interact with commerce partners 200 such as on-line catalogs, stores, or information providers in a manner consistent with the preference and matching criteria the user has selected and set in the system 160. This communication may include active user interaction such as purchasing of a product or service through the communication vehicles provided by the current invention or may include information that system users act upon while not currently using the present invention.

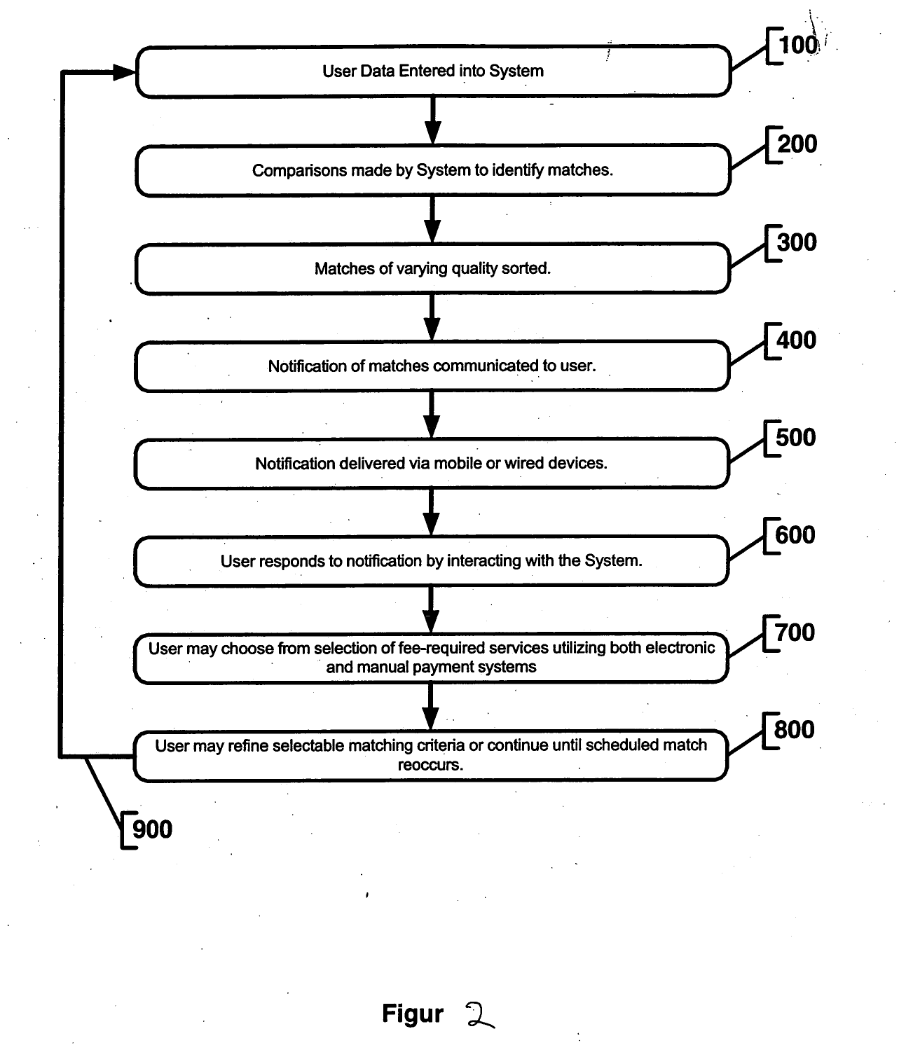

A method of the present invention generally corresponding to the use of the system of FIG. 1 may also be provided as illustrated in FIGS. 2 through 6. In a first step, users can enter characteristic and or criteria data into a database 100, for example, by telephone through the use of a custom Interactive Voice Response application developed using Sonexis Show N Tel software. Alternatively, data may be entered by user dictation to a live call center representative who utilizes custom data entry software developed using Great Plains Dexterity software. Other suitable computer hardware and software combinations may be substituted in order to achieve this 100 step, and may include the systems described in U.S. Pat. No. 5,893,111, entitled Ad Taking Pagination Information System, and issued on Apr. 6, 1999; and U.S. Pat. No. 6,073,105, entitled Interactive Personals Online Network Method and Apparatus, and issued on Jun. 6, 2000, both of which are incorporated herein by reference.

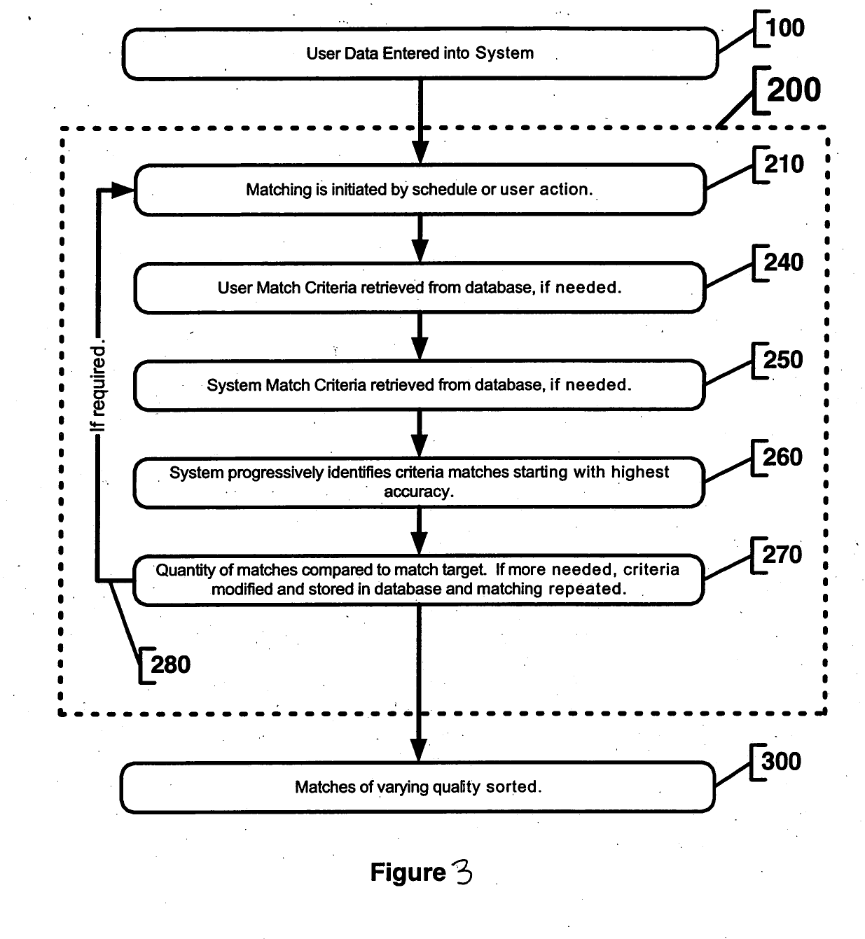

Comparisons are made by the system 200 utilizing the methods detailed more fully in FIG. 3. Matching can be initiated by either user action such as immediately after a new user enters their criteria in the database or by a system scheduled means 210. In the scope of this invention, scheduled means may include, but are not limited to system conditions such as available computer processing time, data changes such as the addition of new possible matches, and not merely based on specific time cycles.

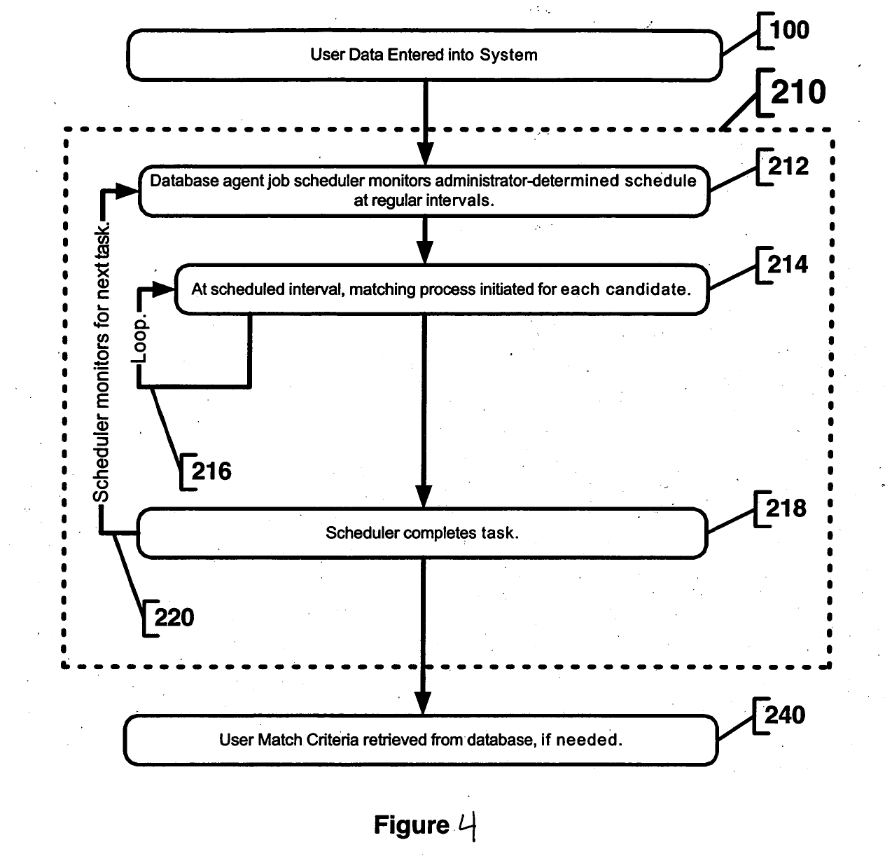

As shown in FIG. 4, automated task schedulers, such as those associated with database management systems (DBMS), may be used to initiate matching 210 by monitoring an administrator-established schedule 212. A matching process is initiated for each eligible candidate who meets the pre-determined criteria for this task 214. This process of initiation can be repeated until matching has been started for each candidate under the specific rules of this automated task 216. The scheduled task can then end 218. The scheduling system can continue to monitor the task list at regular intervals 220.

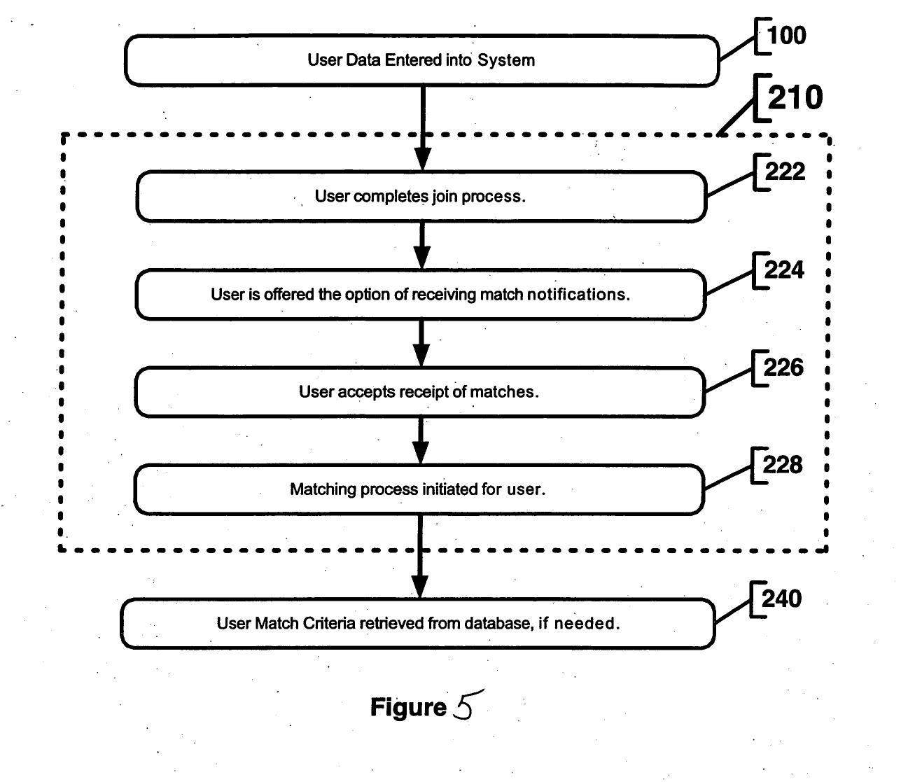

FIG. 5 shows an alternative form of matching initiation 210 whereby a user completes the process of joining the service affiliated with the matching database 222 and is then offered the option of immediately being matched 224. If the user chooses to accept matches 226, the matching process is initiated for that user 228.

User-specific matching criteria are retrieved from the database if appropriate 240. In the preferred embodiment, these criteria include desired characteristics of the individual sought including sex, age, height, and other tangible and non-tangible characteristics. Additionally, if appropriate for the specific match, system-level criteria are retrieved from the database 240. In one embodiment, these criteria include default values such as geographic limits and age limits if not already selected by the user. Further examples of matching elements and techniques can be found above and in U.S. Pat. No. 6,052,122, entitled Method and Apparatus for Matching Registered Profiles, and issued on Apr. 18, 2000; U.S. Pat. No. 6,058,367, entitled System for Matching Users Based Upon Responses to Sensory Stimuli, and issued on May 2, 2000; and U.S. Pat. No. 6,249,282, entitled Method and Apparatus for Matching Registered Profiles, and issued on Jun. 19, 2001, as well as in published United States Patent Application No. 2002/0059370, entitled Method and Apparatus for Delivering Content Via Information Retrieval Devices, and published on May 16, 2002, each of which is incorporated herein by reference.

For each affected user, the system compares the criteria selected in 240 and 250 and progressively finds matches beginning with the closest agreement between criteria and characteristics and then continues with subsequently less stringent matching requirements 260. If sufficient matches are not yet obtained and the matching requirements can still be lessened 270, the process of matching is repeated using the updated criteria 280. In one embodiment, the matching criteria first strictly includes the user's smoking preference when evaluating potential matches, but if an insufficient number of matches are identified, the smoking criteria is excluded from consideration on subsequent attempts to identify matches.

In FIG. 2, block 300 shows that the stored matches are sorted by quality of agreement between user criteria and target characteristics.

Notification of matches is then communicated to the system user 400. The means of delivery of the communication is determined by the user's stored selection or based on the system's default settings as determined by the method by which the user joined the system's service or based upon other automatable criteria. In one embodiment, a user may select a stored preference to be notified of matches by electronic mail delivered to personal computer or other Simple Mail Transfer Protocol (SMTP)/Post Office Protocol (POP) compatible device, by Short Message Service (SMS) delivery via a cellular telephone or other compatible device, or by receiving an automated telephone call utilizing the PSTN switched network to a compatible land-line or cellular telephone.

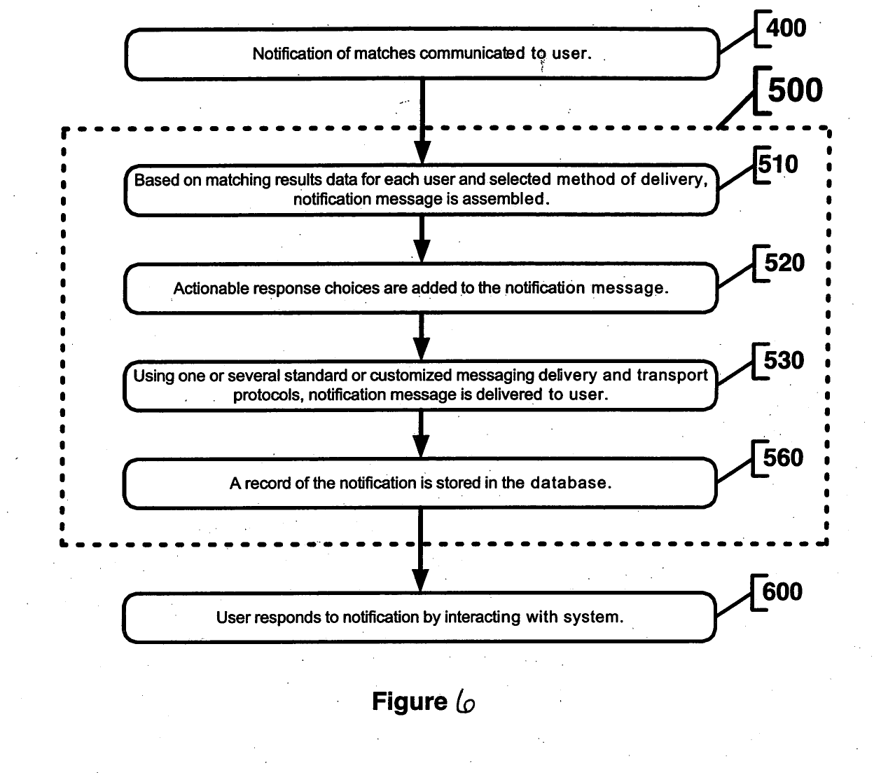

As detailed in FIG. 6, once the method of delivery is determined 400, and based on that delivery methodology, the notification message is assembled using some or all available data about the predetermined matches as stored or referenced in the database 510. Notification messages can contain text, audio, video, still graphic imagery, universal resource locator (URL) or other links to external material, or other types of content. In one form of the invention, an outbound telephone call utilizing the PSTN switched telephone network is prepared by identifying one of a user's matched profiles, gathering data about that user from the database including a reference to a file containing the match's self-recording of his first name, the match's descriptive characteristics, and informative content based on the user's profile. In another embodiment, a notification is constructed for delivery via SMS and therefore utilizes abbreviated text descriptions to fit within character delivery limitations.

Additionally, content detailing the means of responding to the matches or making adjustments of the user's matching criteria among other action options are also added to the notification message 520. In one embodiment, such notifications may include a telephone number which a user may use to call either a live operator or a dynamic interactive voice response (IVR) computer-telephony integrated system which allows the recipient to hear additional data about the matches. In another encompassed embodiment, a user is given a uniform resource locator (URL) through which a recipient, while using a computing device which may utilize the world wide web (WWW) or other data network, may gain access to additional match information including being informed of means of possible interaction with the matched user's data. From none to many such response mechanisms may be detailed for a user as part of this notification system 520.

Using one or more standard or customized messaging delivery and transport protocols, the notification message is delivered to the user 530. This delivery may be made by utilizing SMTP/POP, PSTN switched telephone network calls with automated message playback, SMS, instant messaging protocols, or other means. Devices targeted to receive these messages may include mobile telephones, pagers, handheld e-mail devices, land-line telephones, personal computers, or other messaging or communications devices. Notifications, or other advertising content (which can also be based upon user data or matching preferences) can be provided as described above or according to the examples of messaging illustrated in published United States Patent Application Nos. 2002/0055351, entitled Technique for Providing Personalized Information and Communications Services, and published on May 9, 2002; 2002/0059116, entitled Method and System for Selectively Displaying Advertisements on a Display Device, and published on May 16, 2002; and 2002/0059370, entitled Method and Apparatus for Delivering Content Via Information Retrieval Devices, and published on May 16, 2002, each of which is incorporated herein.

A record of the notification delivery is stored in the database in a manner which can be associated to the user 560.

As shown in FIG. 2, following receipt of the notification message 500, user may respond utilizing multiple means 600. In one form of the invention in which the user receives a notification via SMS, the user may use their mobile telephone to select the response telephone number included in the message and place a call to the system. In another form of the invention, the user may review the matching materials received in an electronic mail and follow the embedded instructions for reaching the system to respond to the identified match 700. A record of any response may also be stored in one or more databases, and such responses may be used to determine further matching and/or advertising by the system.

Following the receipt of a match or at other times, the user may modify their matching criteria 800. This change may lead to an immediate repeat of the matching process 900 or matching may only reoccur on the system's scheduled basis 800. Additionally, the user may simply allow the matching to reoccur on the system's schedule 800.

Referring again to the system of the invention of FIG. 1, a number of representative experiences of users of the system can be described. The present invention can encompass, for example, live text or voice chat between two or more individuals. In one embodiment, a first user, “Ua”, sends an SMS text message indicating “join” from a personal cell phone 10 to an advertised SMS receiving address for the service. This SMS message is routed through Ua's cellular phone gateway 80 through the public Internet 140 to the Preference and Matching Database System 160 which creates a new anonymous record for the user. The system responds to Ua through the same conveyance with several profile questions and billing, payment, and usage terms. Following successful approval for use by the payment and accounting systems 150, and based on Ua's responses, the system 160 identifies a compatible match with a second user, “Ub”, who is similarly engaged with the system and notifies Ua of Ub along with a temporary alpha-numeric identifier which can be used to communicate in real-time via SMS with Ub.

In a further example of this use of the present invention, the system 160 may suggest additional or alternative available users to Ua and Ub as well as possible activities or offers relevant to Ua and Ub based on the profile detail provided utilizing the connections to commerce partners 200.

In yet another variation of this example, Ua may further be matched with a third user, “Uc”, who is participating in the system by establishing a voice connection using a standard analog telephone 60, connecting to an audiotext system 180 associated with the present invention which allows Uc to speak messages to Ua utilizing Speech-to-Text capabilities integrated into the audiotext system. Responses sent from Ua to Uc are “spoken” to Uc via Text-to-Speech capabilities integrated into the audiotext system.

In a further example Ua may be matched to a fourth user, “Ud”, who is accessing the Preference and Matching Database System 160 via e-mail utilizing a personal computer 40 through a commercial ISP e-mail account 110. Similar to the examples above, the system 160 allows the users to communicate across the platform differences transparently so Ua can send and receive the communications via SMS text messaging 10 that Ud is receiving and sending via e-mail 40.

In a different example illustrating the present invention, a user, “Ue”, joins the service hosted by the Preference and Matching Database System 160 by navigating to a hosted World Wide Web site using a browser on a personal computer 50 in order to select a user identity for use within the system. Ue sets personal preferences and identifies important search criteria for finding a sports partner for a tennis match in or near a particular city within a selected time range. In other possible uses of the present invention, Ue could enter search criteria for finding individuals with whom to talk or communicate on any topic, or for seeking a companionship such as with a personals service, or to identify expert or skilled assistance with some task or project. Alternatively, Ue could be seeking information on a service or product or location and travel directions such as from commerce partners 200.

Within this same embodiment of the present invention, a user, “Uf”, selects personal preferences and characteristics by using a landline telephone 60 via a standard PSTN telephone connection 190 to call a live customer service representative 170 who enters Uf's data into the Preference and Matching Database System 160. Uf also selects a preferred method of being notified of matches generated by that system. Such means of notification can include an automated telephone call from a Text-to-Speech system in an audiotext system 180; a message delivered by e-mail 40, instant messenger 30, or SMS text message 10; a retrievable message via a web browser 50 or a voicemail message via telephone 180; or by other means.

In the present embodiment where Ue is seeking a sports partner, the Preference and Matching Database System 160 searches the existing profiles and, finding a match with Uf, communicates the results via SMS 10 to Ue along with information as to whether Uf is immediately available for communication using any of the compatible means such as SMS and SMS, SMS and instant messenger 30, SMS and Text-to-Speech via telephone 60, or other appropriate combinations. In addition, Ue may be notified of recommended locations for tennis with Uf or convenient restaurants and shops to the selected location via information collected from commerce partners 200.

In yet another distinct embodiment of the present invention, a user, “Ug”, who is a seeking a companion, using a web browser 50, has registered with the Preference and Matching Database System 160. During the same or a subsequent user session, Ug using a web browser, reviews the matches and corresponding public profiles identified by the system. This match result also displays choices of means of anonymous, or in some cases personally identifiable, communication. For example, Ug sees that another user who has matched his criteria, “Uh”, can be messaged by either e-mail or SMS. If Uh is currently active within the system, an additional indication is made in Ug's results showing that Uh can immediately be contacted for real-time, anonymous communication. In this example, Ug may see that Uh is active on the system using SMS. Ug may then either initiate a communication using the web browser to send messages through the system 160 to Uh which Uh will receive on her SMS-capable device. Alternatively, Ug may send SMS messages from an appropriate device directly to the system using a system provided temporary alpha-numeric identifier which will be used by the system to route the contents on the message to Uh.

A person of ordinary skill in the art will appreciate further features and advantages of the invention based on the above-described embodiments. For example, specific features from any of the incorporated United States patent documents may be incorporated into systems or methods of the invention as well as features referred to in the claims below which may be implemented by means described herein and in the incorporated United States patent documents. Accordingly, the invention is not to be limited by what has been particularly shown and described, except as indicated by the appended claims or those ultimately provided. All publications and references cited herein are expressly incorporated herein by reference in their entity.

1. A method for transferring and communicating data between a mobile device from a wireless network requested from a database connected to a network, comprising:
storing data onto a server;
connecting to a wireless network;
requesting data from a mobile device;
transmitting data from the mobile device to the server;
matching data from the wireless device to the data on the server; and
transferring other data from the server to the wireless device.

2. A method according to claim 1, wherein the mobile device is a mobile phone, a personal digital assistant (PDA), or a paging device.

3. A method of claim 1, wherein the data includes information from a retailer or service provider within the vicinity designated by the user's selection.

4. A method of claim 3 wherein the information includes advertising information.

5. A method of claim 1, further comprising: creating a user profile on the mobile device; posting the data onto a server on the network.

6. A method of claim 5, wherein the data includes user preferences.

7. A method of claim 5, wherein the data is matched to data on a server located on the network.

8. A method of claim 7, wherein the results of the data matched is categorized to the level of accuracy of the match.

9. A method of claim 1, 8, wherein a messaging means is communicated to the mobile device via a wireless network.

10. A method in a server for providing data to a mobile device comprising the steps of:
receiving a request for matching information via a wireless network; and
selectively providing matching information to the mobile device for storage therein and displaying to the user.

11. A method in a mobile device for displaying information targeted to a user's profile comprising the steps of:
receiving information to be stored in memory of a mobile device;
displaying data on the mobile device in accordance with the user's selection; and
displaying targeted information for display on the mobile device.

12. A method of claim 11 wherein the information includes text and graphics.

13. A method of claim 11 wherein the targeted information includes user selectable options.

14. A method of claim 11, further comprising the steps of:
displaying billing options on the mobile device;
storing the user billing selection on a network server;
monitoring the actions of the user on the mobile device in relation to the billing options; and
storing billing information on the network server.

15. A method for communicating to Internet websites using a mobile device connected to a wireless network, comprising:
transmitting data from the mobile device to a server on the network;
checking for user preferences on the network server;
sending the user matching information including text and graphics based on the user profile; and
displaying the matching information on the mobile device.

16. A method according to claim 15, wherein the matching information identifies by messaging means the availability of at least one product or service.

17. A method according to claim 16, wherein the user of the mobile device may communicate in real-time via voice means or electronic messaging means with a representative of the at least one product or service.

18. A method according to claim 15, wherein the user of the mobile device may communicate in real-time via voice means or electronic messaging means with a person represented by the matching information provided to the mobile user.

19. A method according to claim 18, wherein the real-time communication means is an electronic messaging means and electronic messages sent on the electronic messaging means include at least one of text and graphics relating to the mobile user, or a link or address representing the location of text and graphics relating to the mobile user.

20. A system for matching users with profile data of interest to that user to establish real-time interactive communication with another user related to the matched profile data, the system comprising:
a matching database system including a means for entering profile data, a means for matching a user's profile to other profiles, and a notification messaging means for sending notification messages to a user to indicate matches made, the matching database system having stored therein a plurality of profiles containing profile data; and
a means for allowing users to communicate with the matching database system to enter profiles containing profile data and to receive the notification messages;
wherein the notification messages allow the user receiving a notification message to communicate interactively in real-time with a representative of a matched profile.

21. The system of claim 20, wherein the profile data includes characteristic and criteria data and the matching is bi-directional.

22. The system of claim 20, wherein the means for matching includes a means for determining whether a representative of a matched profile is available for real-time interactive communication through a communication means that is compatible with a communication means used by a matching user.

23. The system of claim 20, wherein the real-time interactive communication is anonymous.
